(19) United States
(12) Patent Application Publication
(10) Pub. No.: US 2010/0086661 A1
(43) Pub. Date: Apr. 8, 2010

(54) Method for preparing lasagna

(76) Inventor: Samantha A. Kendall, Chicago, IL (US)

Correspondence Address: HURLEY STANNERS, LLC, 1011 LAKE STREET, OAK PARK, IL, 60301-1137, US

(21) Appl. No.: 12/106,298

(22) Filed: Apr. 19, 2008

Related U.S. Application Data
(60) Provisional application No. 60/912,927, filed on Apr. 20, 2007.

(51) Int. Cl. A23L 1/16

(52) U.S. Cl. 426/557

(57) ABSTRACT

The present invention relates to a method of preparing a lasagna dish. The ingredients may include chicken breast, mozzarella cheese, cheddar cheese, lasagna pasta, pasta sauce, spaghetti seasoning, ricotta mix, and olive oil. The novel method of preparing includes cooking the chicken twice. The cooked lasagna pasta noodles are used to create layers between the above-listed ingredients.

### FIELD OF THE INVENTION

The present invention relates generally to a method for preparing a food dish, and more particularly relates to a method for preparing lasagna.

### BACKGROUND OF THE INVENTION

The food product that this invention relates to is commonly referred to as lasagna. Lasagna may typically be prepared with ingredients such as cheeses, sauces, pasta, and meat.

### SUMMARY OF THE INVENTION

The present invention relates to one or more of the following features, elements or combinations thereof. The present invention includes the ingredients of boneless skinless chicken breast, mozzarella cheese, mild cheddar cheese, lasagna pasta, pasta sauce, spaghetti seasoning, ricotta mix, and olive oil. The novel method of preparing includes cooking the chicken at least twice. The cooked lasagna pasta noodles are used to create layers between the above-listed ingredients.

### DETAILED DESCRIPTION OF EMBODIMENTS OF THE INVENTION

In one embodiment, a lasagna product can be constructed in a ½ deep aluminum pan (or any other type of pan suitable for baking in an oven) for immediate cooking or for freezing for up to, for example, six weeks. In the preferred embodiment, the lasagna product includes the following ingredients: three to five boneless chicken breasts, approximately 1 cup of mozzarella cheese, approximately 1 cup of mild cheddar cheese, ¼ cup to 1 cup of ricotta cheese (optional), approximately 1 egg or 1 egg white, approximately four cups of pasta sauce, somewhere between 6-11 lasagna pasta egg noodles, four tablespoons olive oil, and four tablespoons of spaghetti seasoning. The lasagna egg noodles may be substituted with wheat lasagna noodles, roasted red pepper noodles, spinach and basil noodles, tomato-basil noodles, or any other type of lasagna noodle that can provide the desired taste. The pasta sauce can be substituted with tomato sauce, artichoke sauce, sun-dried tomato sauce, portabella mushroom sauce, or any other sauce that could provide the desired flavor to the dish. The spaghetti seasoning illustratively includes dried green and red peppers, black pepper, cilantro, and oregano. However, it should be understood that other seasonings may be substituted, for example, Italian seasoning. Another seasoning combination could include dry roasted green peppers, red peppers, and a pinch of salt. Additionally, vegetables can be added to any of these recipes.

A disclosed method for making the lasagna product is as follows:

If ricotta is being used, create the ricotta mix. In a medium bowl, mix the egg (or egg white) and ricotta until evenly mixed. This mix can then be stored in the refrigerator to retain freshness.

Prepare the lasagna noodles. Bring, for example, five quarts of water to boil in a large pot. Add approximately six to 11 lasagna noodles and watch carefully for noodles to curve in the pot. Stir delicately and separate noodles, cooking uncovered for approximately 23 minutes, stirring occasionally. Drain water from cooking pot and place each noodle flat on a sheet of aluminum foil.

Prepare the chicken breast in the following manner. This can be done while the above-referenced noodles are boiling; rinse and clean chicken by removing excess fat. Heat water (or in the alternative, olive oil) in a large pan. The use of water instead of olive oil can result in a unique flavor and improved consistency. Furthermore, it is considered healthier by most.

Place chicken breast in pan and sauté in the water (or oil) until the exterior is seared on both sides. Such searing step seals in the moisture in the chicken breast. At this point, further cooking could be accomplished by covering the chicken with a lid and cooking for 30 minutes. Check the chicken for degree of done-ness.

Rather than cooking by covering the chicken with a lid, another second step could be employed. The chicken breast could be placed in an aluminum pan to bake in an oven. While heating the water above, pre-heat the oven to approximately 350 degrees Fahrenheit. Once the chicken has sautéed, place the chicken breast in the oven and bake until the chicken is thoroughly cooked. Remove the chicken from the oven and let it cool for five minutes or more.

In the alternative to the above-mentioned chicken preparation steps, one can steam the chicken in the following manner. Run approximately 1 to 4 cups of water in a pot (amount of chicken will dictate amount/level of water), use 2 cups for one chicken breast and increase amount of water for each chicken breast being steamed (optional-place a cube of ginger and mango slice in water or fruits or vegetables to your desired taste); place colander designed for the pot directly over, place chicken breast in colander and cover, let steam for 15 minutes, remove lid and turn chicken breast over, cover with lid and steam for 10 additional minutes, remove lid-placing it on your counter top safely, remove chicken, let cool and shred to prepare for lasagna layering. Steamed vegetables are a substitute for chicken breast (for example, asparagus, broccoli, bell peppers, onions, and more).

In yet another embodiment, the chicken can be cooked rotisserie-style with the chicken left on the bones and the skin left on the chicken. In this embodiment, the chicken can be prepared substantially as follows.

Season the inside of the chicken with an orange or yellow bell pepper slice & one small cube of ginger; or use vegetables of your choice to season. Of course, other flavors and seasonings may be introduced, such as fruit. Place the chicken breast onto a rotisserie and set the grill on high. Cook for 5 minutes.

Immediately after placing chicken breast into rotisserie, mix together one tablespoon to one cup of melted butter, one lemon (freshly squeezed) and one dash of pepper. Turn the grill down to medium and baste the chicken breast with the butter mixture (the lemon in the butter mixture can be replaced with freshly squeezed orange or other fruits blended prior). Close the lid and cook for 45 minutes to one hour, basting occasionally, until the internal temperature reaches 180 degrees F. (83 degrees C.) using a meat thermometer.

Remove the ricotta mix (if being used) from the refrigerator. Layer the ingredients with the noodles in the following manner. In the selected size of pan, place three lasagna noodles at the bottom of a deep aluminum pan in a lengthwise manner. (In an alternative embodiment, this step can be skipped and the ricotta can be spread on the bottom of the lasagna pan instead of the noodles.) Spread approximately two tablespoons of ricotta cheese evenly on each noodle (or on the pan) and spread approximately four tablespoons of pasta sauce evenly over the ricotta cheese; shred the two cooked chicken breasts, preferably with your hands, and place evenly on top of the previous layers. Sprinkle two tablespoons of spaghetti seasoning and mozzarella cheese over this first layer. Repeat layers using cheddar cheese. Top off the dish with lasagna noodles. Cover with aluminum foil, place in approximately 350 degree Fahrenheit oven, and bake until the cheese has melted. In a convection oven, the cooking time may be approximately seven minutes. In a conventional oven, the cooking time may be approximately 30 minutes. Once the cheese is melted, remove pan from oven and spread the remaining spaghetti sauce on top or slice-serve lasagna and then place spaghetti sauce on slice. If desired, the lasagna product can be frozen for a period of time.

In one alternative, vegetables can be used instead of meat. For example, steamed broccoli, sautéed orange and yellow bell peppers, sautéed squash (yellow), and fresh spinach are contemplated as excellent vegetables or use in place of the meat. As with the chicken, all vegetables can be twice baked. The broccoli can be steamed and the other vegetables can be sautéed. The layering of the lasagna is as disclosed herein, with the exception that the meat is replaced with the vegetables.

In another alternative, tofu may be used in place of ricotta, and vegetable cheese can be used in place of the mozzarella and cheddar layers.

Still another organic recipe is contemplated, incorporating organically grown vegetables, such as orange and golden yellow bell peppers, yellow squash, fresh spinach, and fresh broccoli. The broccoli can be steamed prior to layering the product. The other vegetables can be sautéed as set forth above.

In yet another embodiment, a Mexican-style chicken recipe can be implemented. Pasta or flour tortillas can be used in the recipe. A range of five to 12 flour tortillas can be used. All other processes remain the same. Organic Mexican lasagna can also be prepared, or even a low fat version.

Instead of using pasta, the flour tortillas can be used. In the Mexican-style embodiment, the ingredients include ½ cup chopped onion (red or yellow), cilantro, ½ teaspoon of salt, four chicken breasts, and olive oil. (Fresh lime juice is put to the side.)

To prepare, put olive oil in a pan and sauté all ingredients. The meat is prepared the same way as disclosed above. Layer the product and squeeze fresh lime juice over the final layer before placing the next tortilla on it.

Hot pepper juice can be served on the side of it for taste. This embodiment contemplates that other meats can be used, as well. Also, the product can be made with a pinch of oregano.

While the disclosure is susceptible to various modifications and alternative forms, specific exemplary embodiments thereof have been shown by way of example and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure.

What is claimed is:

1. A method of preparing a dish of lasagna, the method comprising the steps of:
boiling a plurality of lasagna noodles;
sautéing chicken breast;
placing the sautéed chicken breast in the oven in order to further bake the chicken;
preparing a seasoning mixture;
spreading a layer of sauce on a pan;
placing a first layer of the lasagna noodles across the pan;
shredding the chicken breast and placing as another layer across the pan;
sprinkling some of the seasoning mixture across the chicken;
spreading a layer of mozzarella cheese across the top of the seasoning mixture and chicken;
placing a second layer of lasagna noodles across the pan;
shredding the chicken breast and placing it as another layer across the pan and on top of the second layer of lasagna:
sprinkling some of the seasoning mixture across the second layer of chicken;
spreading a layer of cheddar cheese across the top of the seasoning mixture and chicken;
placing a top layer of lasagna noodles across the pan; and
placing the dish of lasagna in a heated oven such that the chicken is cooked a third time while the dish of lasagna is baked.

2. The method of claim 1, further comprising the step of preparing a mixture of ricotta cheese and eggs.

3. The method of claim 2, further comprising the step of spreading the ricotta cheese and egg mixture across the pan prior to spreading a layer of sauce on the pan.

4. The method of claim 1, wherein the seasoning mixture comprises dried green and red peppers, black pepper, cilantro, and oregano.

5. The method of claim 1, further comprising the step of freezing the lasagna prior to placing it in the oven.

6. The method of claim 1, further comprising the step of adding a layer of sautéed vegetables.

7. The method of claim 1, further comprising the step of adding a layer of tofu.

8. The method of claim 1, wherein the lasagna noodles are flour tortillas.

9. A method of preparing a dish of lasagna, the method comprising the steps of:
boiling a plurality of lasagna noodles;
steaming chicken breast;
preparing a seasoning mixture;
spreading a layer of sauce on a pan;
placing a first layer of the lasagna noodles across the pan;
placing the chicken breast as another layer across the pan;
sprinkling some of the seasoning mixture across the chicken;
spreading a layer of mozzarella cheese across the top of the seasoning mixture and chicken;
placing a second layer of lasagna noodles across the pan;
placing additional chicken breast as another layer across the pan and on top of the second layer of lasagna:
sprinkling some of the seasoning mixture across the second layer of chicken;
spreading a layer of cheddar cheese across the top of the seasoning mixture and chicken;
placing a top layer of lasagna noodles across the pan; and
placing the dish of lasagna in a heated oven such that the chicken is cooked a third time while the dish of lasagna is baked.

10. The method of claim 9, further comprising the step of preparing a mixture of ricotta cheese and eggs.

11. The method of claim 10, further comprising the step of spreading the ricotta cheese and egg mixture across the pan prior to spreading a layer of sauce on the pan.

12. The method of claim 9, wherein the seasoning mixture comprises dried green and red peppers, black pepper, cilantro, and oregano.

13. The method of claim 9, further comprising the step of freezing the lasagna prior to placing it in the oven.

14. The method of claim 9, further comprising the step of adding a layer of sautéed vegetables.

15. A method of preparing a dish of lasagna, the method comprising the steps of:
boiling a plurality of lasagna noodles;
cooking chicken breast on a rotisserie grill;
preparing a seasoning mixture;
spreading a layer of sauce on a pan;
placing a first layer of the lasagna noodles across the pan;
placing the chicken breast as another layer across the pan;
sprinkling some of the seasoning mixture across the chicken;
spreading a layer of mozzarella cheese across the top of the seasoning mixture and chicken;
placing a second layer of lasagna noodles across the pan;
placing additional chicken breast as another layer across the pan and on top of the second layer of lasagna:
sprinkling some of the seasoning mixture across the second layer of chicken;
spreading a layer of cheddar cheese across the top of the seasoning mixture and chicken;
placing a top layer of lasagna noodles across the pan; and
placing the dish of lasagna in a heated oven such that the chicken is cooked a third time while the dish of lasagna is baked.

16. The method of claim 15, further comprising the step of preparing a mixture of ricotta cheese and eggs.

17. The method of claim 16, further comprising the step of spreading the ricotta cheese and egg mixture across the pan prior to spreading a layer of sauce on the pan.

18. The method of claim 15, wherein the seasoning mixture comprises dried green and red peppers, black pepper, cilantro, and oregano.

19. The method of claim 15, further comprising the step of freezing the lasagna prior to placing it in the oven.

20. The method of claim 15, further comprising the step of adding a layer of sautéed vegetables.
